(19) United States
(12) Patent Application Publication
(10) Pub. No.: US 2025/0352885 A1
(43) Pub. Date: Nov. 20, 2025

(54) VARIABLY BIASED MULTIDIRECTIONAL WHEELED SUPPORT DEVICE

(71) Applicant: Benjamin SMITH, Telford, PA (US)

(72) Inventor: Benjamin SMITH, Telford, PA (US)

(21) Appl. No.: 19/213,844

(22) Filed: May 20, 2025

Related U.S. Application Data
(60) Provisional application No. 63/649,772, filed on May 20, 2024.

(51) Int. Cl. A63C 17/22; A63C 17/04; B60B 19/00

(52) U.S. Cl. CPC A63C 17/22; A63C 17/014; B60B 19/003

(57) ABSTRACT

A multidirectional support device is configured to move upon a traversed surface and includes a base. A multiaxial mobility element is attached to the base and includes main and secondary rolling elements having a main rolling axis and a secondary rolling axis The main rolling element is configured to allow rolling about the main rolling axis, and the secondary rolling element is configured to allow rolling about the secondary rolling axis. The multiaxial mobility element is arranged to support the base in a first stabilized equilibrium when the base is moving on the traversed surface and supported by the multiaxial mobility element. A controlled-mobility element is configured for controlled mobility and attached to the base. In the first stabilized equilibrium, the controlled-mobility element does not impede multidirectional movement of the device; and in a second stabilized equilibrium, the controlled-mobility element engages the traversed surface, impeding the multidirectional movement.

### CROSS-REFERENCE TO RELATED APPLICATIONS

This application claims the benefit of priority under 35 USC § 119(e) of U.S. Provisional Patent Application No. 63/649,772 filed May 20, 2024, the contents of which are incorporated herein by reference.

### BACKGROUND OF THE DISCLOSURE

In the field of mobility systems, omnidirectional movement is a significant area of research and development, with applications ranging from robotics to recreational equipment. Traditional wheel systems often limit movement to linear or curvilinear paths, which may require complex maneuvers to achieve multidirectional navigation. Sor example, see the devices of U.S. Pat. No. 3,789,947. Omni-wheels and other similar wheel modules have been designed to allow movement of greater complexity than the linear or the curvilinear path of a wheel. These wheel modules are utilized in various applications, including robotics and automated systems.

The present disclosure relates to modular wheel systems, specifically focusing on omni-wheel technology designed for dynamic omnidirectional mobility. Certain devices of the present disclosure include components such as rolling elements, multiaxial mobility elements, and controlled-mobility elements to facilitate selected controllable behavior, enabling applications across various domains including recreational equipment and other conveyances.

### SUMMARY

In a first embodiment, a multidirectional support device is configured to move upon a traversed surface. The multidirectional support device may include: (a) a base; (b) a multiaxial mobility element attached to the base, the multiaxial mobility element including (i) a main rolling element having a main rolling axis (M) and a secondary rolling element having a secondary rolling axis(S), the main rolling element being configured to allow rolling about the main rolling axis (M), and the secondary rolling element being configured to allow rolling about the secondary rolling axis(S); (ii) the multiaxial mobility element being arranged to support the base in a first stabilized equilibrium when the base is moving on the traversed surface and supported on the traversed surface by the multiaxial mobility element, so that the base has multidirectional mobility on the traversed surface; (c) a controlled-mobility element configured for controlled mobility and attached to the base so that (i) in the first stabilized equilibrium, the controlled-mobility element does not impede a multidirectional movement of the multidirectional support device; and (ii) in a second stabilized equilibrium, the controlled-mobility element engages the traversed surface and thereby impedes the multidirectional movement of the multidirectional support device.

Advantageous refinements of the invention, which can be implemented alone or in combination, are specified in the dependent claims.

### BRIEF DESCRIPTION OF THE SEVERAL VIEWS OF THE DRAWINGS

The following description of the disclosure will be better understood when read in conjunction with the appended drawings. However, the disclosure is not limited to the precise arrangements and instrumentalities shown. In the drawings:

FIG. 1 is a perspective view of a first device of the present disclosure;

FIG. 2 is an exploded partial view of the device of FIG. 1;

FIG. 3 is a front elevational partial view of the device of FIG. 1;

FIG. 4 is a side elevational view of the device of FIG. 1;

FIG. 5 is a side elevational view of the device of FIG. 1 shown in a first stabilized equilibrium on a traversed surface;

FIG. 6 is a side elevational view of the device of FIG. 1 shown in a second stabilized equilibrium on a traversed surface;

FIG. 7 is a front elevational view of the device of FIG. 1 shown in a first stabilized equilibrium on a traversed surface;

FIG. 8 is a front elevational view of the device of FIG. 1 shown in a second stabilized equilibrium on a traversed surface;

FIG. 9 is a perspective view of a second device of the present disclosure;

FIG. 10 is top elevational view of the device of FIG. 9;

FIG. 11 is a perspective view of a third device of the present disclosure

FIG. 12 is a perspective view of a fourth device of the present disclosure

FIG. 13 is a side elevational view of the device of FIG. 12;

FIG. 14 is a perspective view of a fifth device of the present disclosure

FIG. 15 is a front elevational view of the device of FIG. 14 shown in a first stabilized equilibrium on a traversed surface;

FIG. 16 is a front elevational view of the device of FIG. 14 shown in a second stabilized equilibrium on a traversed surface;

FIG. 17 is a top plan view of a longitudinal half-portion of the device of FIG. 14;

FIG. 18 is a partial view of a longitudinal half-portion of the device of FIG. 14;

FIG. 19 is a front elevational view of half-portion of the device of FIG. 14 shown in a first stabilized equilibrium on a traversed surface;

FIG. 20 is a front elevational view of the half-portion of the device of FIG. 14 shown in a second stabilized equilibrium on a traversed surface;

FIG. 21 is an upper perspective view of the half-portion of the device of FIG. 14 shown with the device of FIG. 14 in a first stabilized equilibrium on a traversed surface;

FIG. 22 is an upper perspective view of the half-portion of the device of FIG. 14 shown with the device of FIG. 14 in a second stabilized equilibrium on a traversed surface;

FIG. 23 is a perspective view of a sixth device of the present disclosure;

FIG. 24 is a front elevational view of the device of FIG. 23;

FIG. 25 is a perspective view of a seventh device of the present disclosure;

FIG. 26 is a perspective view of an eighth device of the present disclosure;

FIG. 27 is a front elevational view of the device of FIG. 26;

FIG. 28 is a perspective view of a tenth device of the present disclosure;

FIG. 29 is a side elevational view of the device of FIG. 28; and

FIG. 30 is a front elevational view of the device of FIG. 28 shown in a first non-braking configuration; and

FIG. 31 is a front elevational view of the device of FIG. 28 shown in a second braking configuration.

### DETAILED DESCRIPTION

Certain terminology is used in the following description for convenience only and is not limiting. The words “right,” “left,” “lower,” and “upper” designate directions in the drawings to which reference is made. The words “inner” and “outer” refer to directions toward and away from, respectively, the geometric center of an object and designated parts thereof. Unless specifically set forth otherwise herein, the terms “a,” “an,” and “the” are not limited to one element but instead should be read as meaning “at least one.” “At least one” may occasionally be used for clarity or readability, but such use does not change the interpretation of “a,” “an,” and “the.” Moreover, the singular includes the plural, and vice versa, unless the context clearly indicates otherwise. “Including” as used herein means “including but not limited to.” The word “or” is inclusive, so that “A or B” encompasses A and B, A only, and B only. The terms “about,” “approximately,” “generally,” “substantially,” and like terms used herein, when referring to a dimension or characteristic of a component, indicate that the described dimension/characteristic is not a strict boundary or parameter and does not exclude minor variations therefrom that are functionally similar. At a minimum, such references that include a numerical parameter would include variations that, using mathematical and industrial principles accepted in the art (e.g., rounding, measurement or other systematic errors, manufacturing tolerances, etc.), would not vary the least significant digit thereof. “Multidirectional movement” refers to movement by a multiaxial mobility element in a direction parallel to a main rolling axis of the multiaxial mobility element—that is, movement in a direction transverse to a main rolling direction of movement created by rolling the multiaxial mobility element about a main rolling axis thereof.

In the present disclosure, “side-cut radius” refers to the resulting radius defined by the orientation and location of mobility elements. In terms of a skateboard as an example, “side-cut radius” is equivalent to the behavior of the variable relative angle of the wheels axes that creates and defines the side-cut radius. In terms of snow sports an actual cut radius along the length of the base defines side-cut radius. These features may define or influence the characteristics of interaction with the traversed surface. For purposes of this disclosure, the phrase “recreational equipment” shall refer to any apparatus, system, or device employed in leisure, sporting, or athletic activities, intended for participant amusement, exercise, competition, or enjoyment. Such equipment explicitly encompasses devices used in board sports, ski sports, skate sports, scooter sports, and extends to analogous or related sporting and leisure activities involving any form of wheeled, sliding, rolling, gliding, balancing, steering, propulsion-assisting, gravity-assisting, or similarly functional components, mechanisms, or structures. For purposes of this disclosure, the term “base” shall broadly encompass any structural body, platform, frame, chassis, housing, or similarly functioning support element to which the disclosed multidirectional support device or mobility element arrangement may be mounted, coupled, integrated, or otherwise operatively associated. While specific embodiments herein may illustrate or exemplify bases particularly suited for recreational equipment or similar leisure-oriented applications, it is expressly recognized and intended that the disclosed multidirectional support device can be practically implemented with bases configured for use across a diverse range of technical fields. Such fields include, without limitation, mobility assistance devices (e.g., wheelchairs, mobility scooters, walkers), robotics and automated systems (e.g., robotic vehicles, manipulators, automated guided vehicles (AGVs)), industrial equipment (e.g., carts, dollies, conveyors), transportation apparatus (e.g., aircraft landing gear assemblies, trailers, luggage systems), as well as any other analogous applications in which traditional wheel structures have conventionally been employed or could reasonably be anticipated for future utilization.

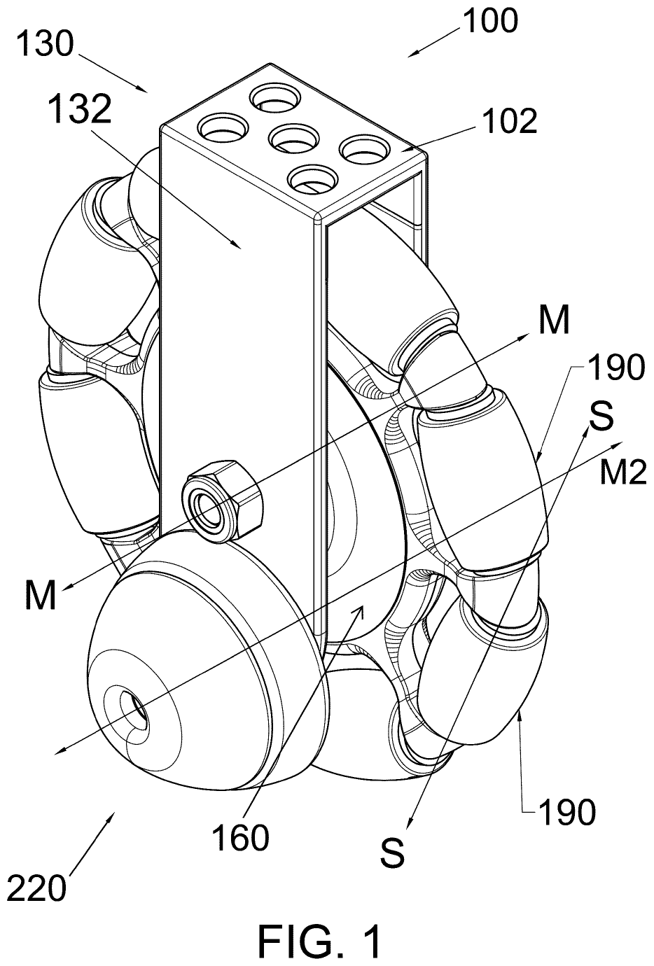

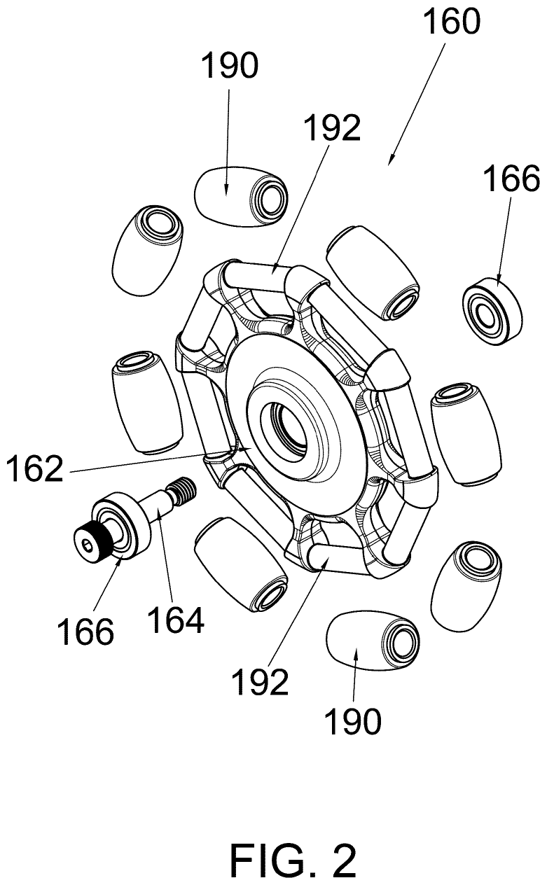

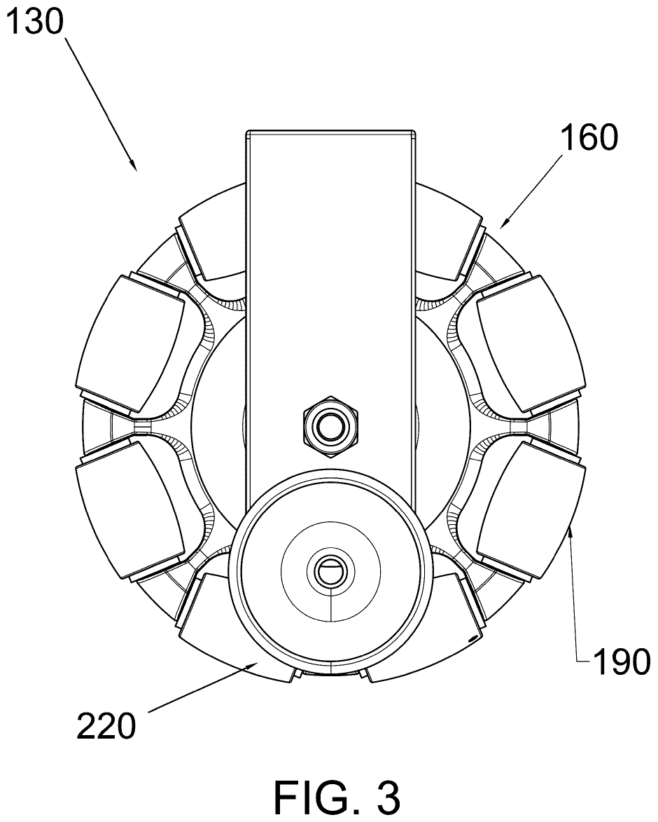

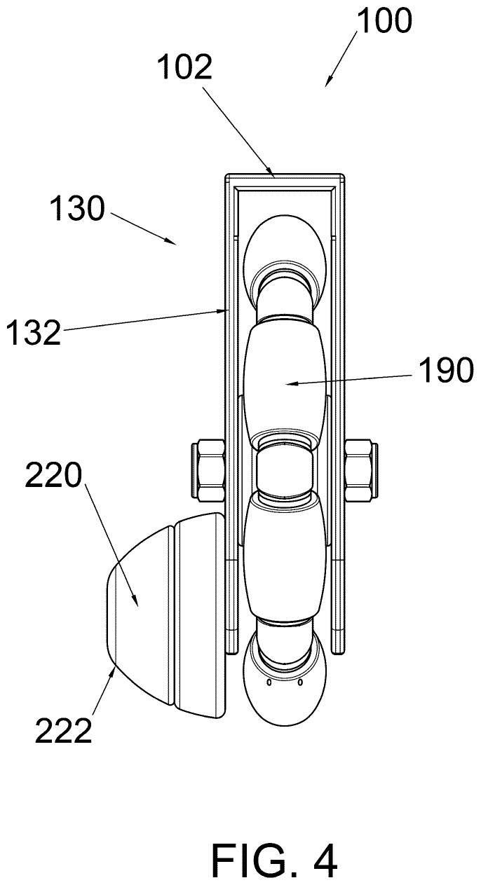

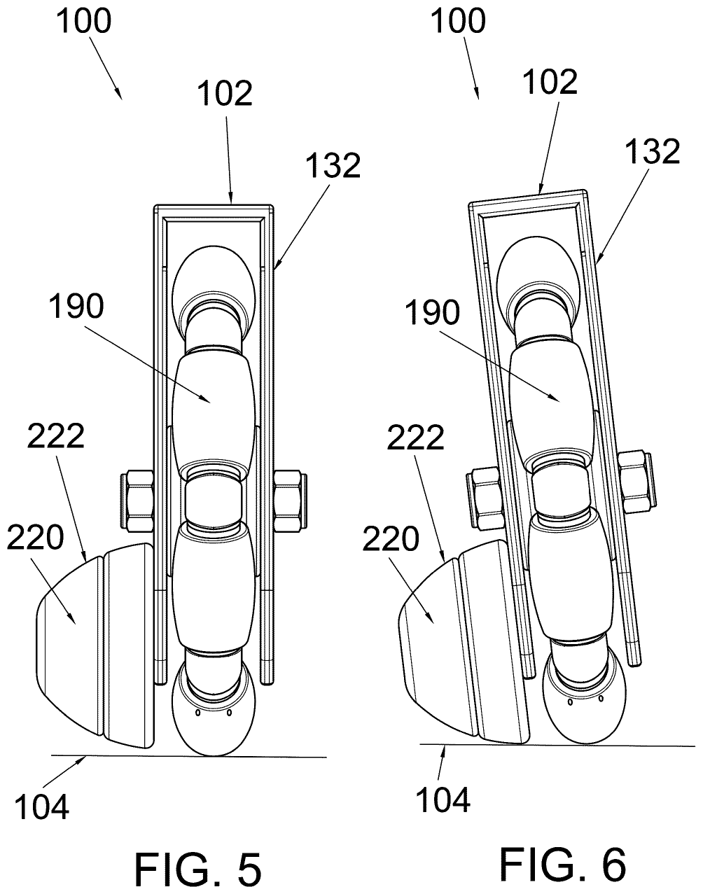

Referring to FIGS. 1-8 of the drawings in detail, wherein like numerals indicate like elements throughout, FIG. 1 is a perspective view of a multidirectional support device 100. The multidirectional support device 100 is configured to move upon a traversed surface 104 (FIGS. 5-8). The multidirectional support device 100 includes a base 102 with mounting holes, which may be located on a top surface thereof as shown. A multiaxial mobility element 130 is attached to the base 102. The multiaxial mobility element 130 includes a main rolling element 160 having a main rolling axis M and a secondary rolling element 190, supported on a shaft 192 as illustrated, having a secondary rolling axis S.

The main rolling element 160 is configured to allow rolling about the main rolling axis M, and the secondary rolling element 190 is configured to allow rolling about the secondary rolling axis S. In the depicted embodiment of FIGS. 1-8, a plurality of elements of the same type as secondary rolling element 190 appear. Each secondary rolling element 190 has its own secondary rolling axis S, although only one such axis is specified in the drawings. In the illustrated embodiment, each secondary rolling axis S may lie in a plane perpendicular to the main rolling axis M.

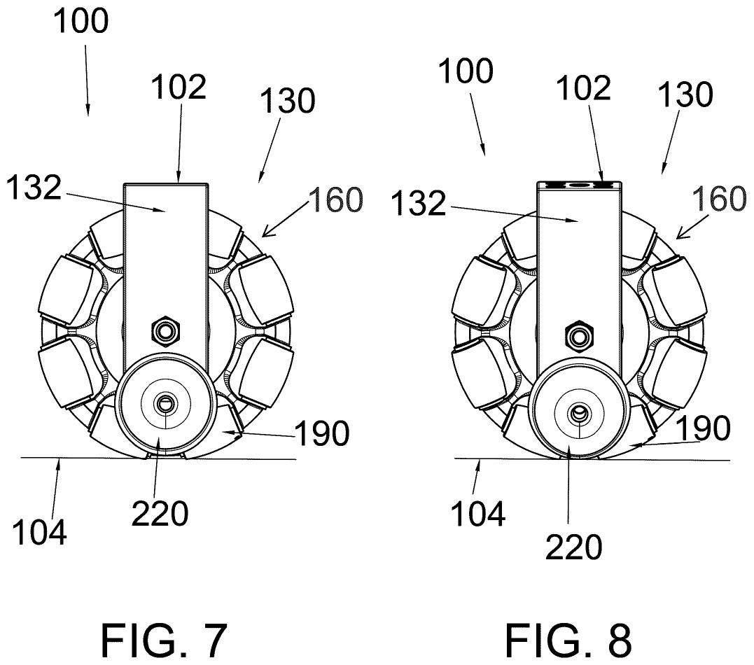

The multiaxial mobility element 130 is arranged to support the base 102 in a first stabilized equilibrium when the base 102 is moving on the traversed surface 104 and supported on the traversed surface 104 by the multiaxial mobility element 130, as shown in FIGS. 5 and 7. In the first stabilized equilibrium, the base 102 has multidirectional mobility on the traversed surface 104 by virtue of the rolling of the main rolling element 160 about the main rolling axis M and/or rolling of the secondary rolling axis S.

A controlled-mobility element 220 is configured for controlled mobility and attached to the base 102 so that in the first stabilized equilibrium, as shown in FIGS. 5 and 7, the controlled-mobility element 220 does not impede a multidirectional movement of the multidirectional support device 100; in the illustrated embodiment, this is so because the controlled-mobility element 220 is not engaged with the traversed surface 104. The first stabilized equilibrium in the illustrated embodiment constitutes a relatively balanced state, in which the multiaxial mobility element 130 supports the base 102, without assistance from the controlled-mobility element 220.

In a second stabilized equilibrium, as shown in FIGS. 6 and 8, the controlled-mobility element 220 engages the traversed surface 104 and thereby inhibits the multidirectional movement of the multidirectional support device 100. The multidirectional movement of the multidirectional support device 100 is inhibited due to the interaction between the controlled-mobility element 220, typically a standard wheel, which may have a tapered face 222, and the traversed surface 104. When the multidirectional support device 100 transitions from the first stabilized equilibrium to the second stabilized equilibrium, interaction between the controlled-mobility element 220 and the traversed surface 104 controls and determines the behavior and path of the multidirectional support device 100. As a result, a user or rider, by controlling a vertical orientation of the user or rider and hence an orientation of the multiaxial mobility element 130, and/or by controlling the amount of force imposed on the controlled-mobility element 220, can cause a transition from the first stabilized equilibrium with a relatively higher degree of multidirectional movement, to the second stabilized equilibrium, with multidirectional movement impeded and either reduced or eliminated entirely (and replaced by movement controlled by the controlled-mobility element 220).

In the embodiment of FIGS. 1-8, the multiaxial mobility element 130, which as depicted is a multiaxial wheel, includes a support frame 132 and is rotatable about a first axis M. The controlled-mobility element 220 is rotatable about second axis M2 oriented parallel to the first axis M. The main rolling element 160, which as shown includes a hub 162 supported on a shaft 164 by bearings 166, has a main rolling resistance, and the secondary rolling element 190 has a secondary rolling resistance, and the secondary rolling resistance may be different from the main rolling resistance, so that the multidirectional support device 100 may to move perpendicularly to the main rolling axis M, in preference to moving parallel to the main rolling axis M, or in another manner as may be selected by the relative values of the main rolling resistance and the secondary rolling resistance. For example, the secondary rolling resistance may be greater than the main rolling resistance, so that the multidirectional support device 100 may tend to move perpendicularly to the main rolling axis M (that is, forward), in preference to moving parallel to the main rolling axis M (that is, sideways). As a result, the multidirectional support device 100 has a natural bias toward movement forward via rotation of the main rolling element 160, while also having the ability to provide sideways movement via rotation of the secondary rolling element 190 (or the plurality thereof).

Except as otherwise discussed below, the elements of the alternative embodiments of support devices are substantially similar to, or substantially identical to, corresponding elements of the multidirectional support device 100. Unless described or shown otherwise, such substantially identical or substantially similar elements have similar or identical characteristics to elements having reference numbers similar to those discussed with respect to the multidirectional support device 100, but with each such reference number increased by a multiple of 1000.

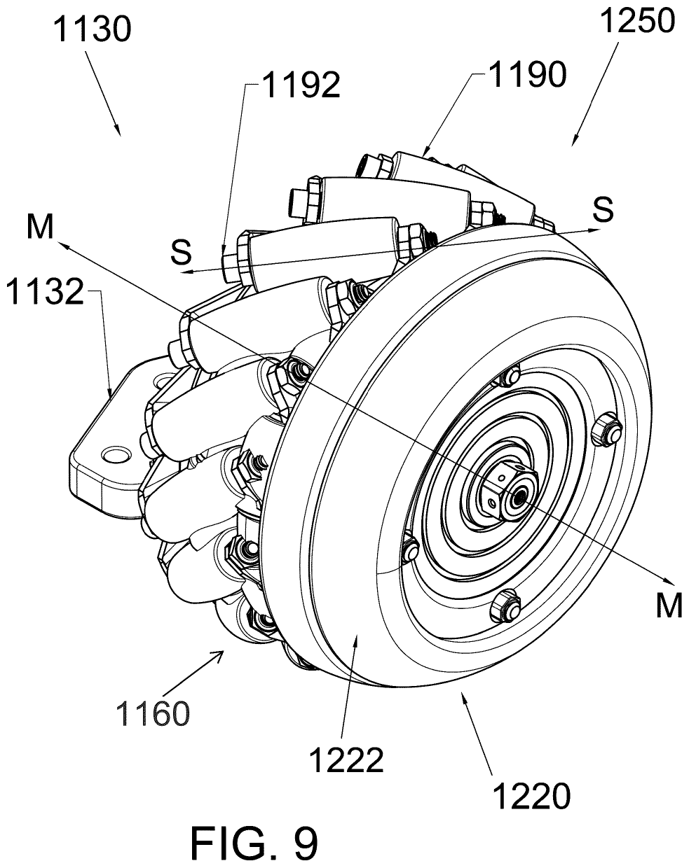

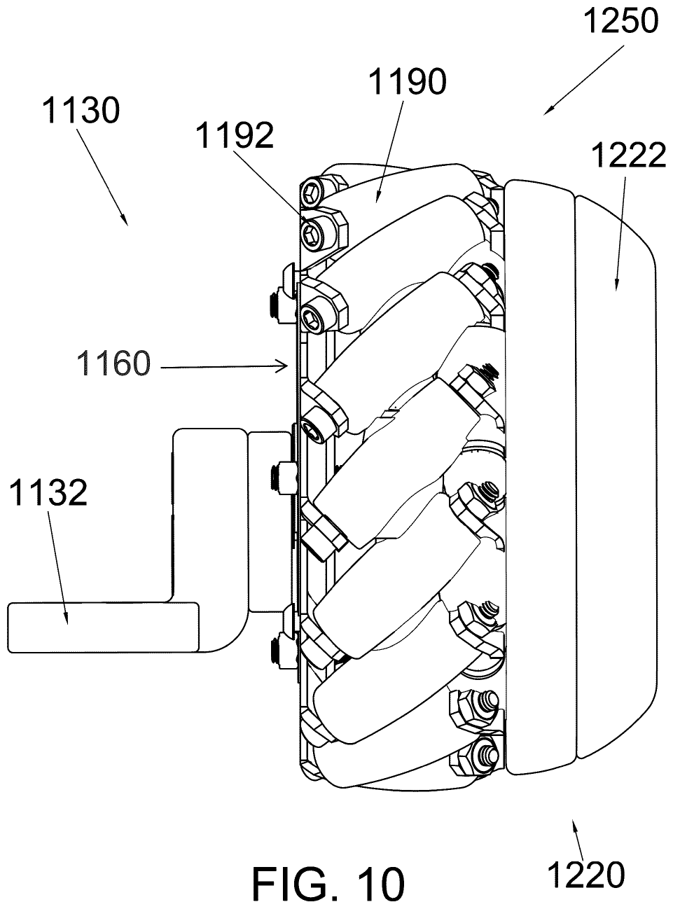

In any embodiment of a multidirectional support device disclosed herein, wherein the main rolling element may include one of a multidirectional wheel 1250 or a Mecanum wheel—for example, the Mecanum wheel disclosed in U.S. Pat. No. 3,876,255 and/or as shown in FIGS. 9-10 as element 1250.

In any embodiment, a multidirectional support device may have a second multiaxial mobility element attached to the base such that upon a deviation from the first stabilized equilibrium, the second multiaxial mobility element provides a restoring force opposing the deviation or driving a return to the first stabilized equilibrium.

In any embodiment, a multidirectional support device 100, further including a drive unit 5310 configured to drive rotation of the main rolling element 160 about the main rolling axis M. A drive unit may include an electric motor, a fuel-powered engine, a mechanical battery, or other suitable power source. A first drive unit and a second drive unit may include two devices driven by power takeoffs (such an input shafts) connected to a common power source of any of the types disclosed herein.

In certain embodiments, a multidirectional support device may include a longitudinal axis and may have a first controlled-mobility element 220 disposed on a first side of the longitudinal axis and a second controlled-mobility element 220 disposed on a second side of the longitudinal axis so that if the multidirectional support device (and in particular the base thereof) leans to the first side or to the second side of the longitudinal axis sufficiently, the controlled-mobility device or the second controlled-mobility device engages the traversed surface 104, thereby reducing a multidirectional movement of the multidirectional support device. For example, see the multidirectional support device 2100, multidirectional support device 3100, and the multidirectional support device 4100.

In any embodiment of a multidirectional support device, the base may have dimensions and characteristics such that the multidirectional support device 100 is appropriately predisposed for functionality as recreational equipment.

In any embodiment, a multidirectional support device may have dimensions and characteristics such that the multidirectional support device simulates or mimics the stability and turning behavior of one of a rideable board-sport device such as a board, ski, skate, or the like. In any embodiment, a multidirectional support device may be configured to provide one or more of the following characteristics: flexing regions rendering the multidirectional support device flexible; variable side-cut radius; variable binding mount features; a plurality of multi-axial mobility elements arranged to provide similar support relative to the traversed surface; minimized multidirectional friction resisting motion; a plurality of controlled-mobility elements arranged to provide similar dynamic mobility influence relative to traditional edge lining control element and traversed surface relationship or a similar such relationship; generation of friction for resisting motion for sliding, slowing, or stopping; traction directed by plurality of contact points for sliding, turning, ‘carving’; or selected geometry relating to desired performance characteristics (which may include widely varying designs and implementations). See, for example, the multidirectional support device 2100, the multidirectional support device 3100, or the multidirectional support device 4100. In the present disclosure, as noted above, side-cut radius refers to the resulting radius defined by the orientation and location of mobility elements. In terms of a skateboard, it is the variable relative angle of the wheels axes that creates and defines the resulting turning radius, which is functionally equivalent to a side-cut radius'. In terms of snow sports an actual cut radius along the length of the base defines side-cut radius, which in turn defines or influences the characteristics of interaction with the traversed surface.

In any embodiment, a multidirectional support device 100, wherein the base 102 is configured to provide one or more of the following characteristics to provide similar support to that provided by a snowboard, snow ski, snow skate, snow-scooter, or other snow-riding equipment: flexing regions rendering the multidirectional support device flexible; variable side-cut radius; variable binding mount features; a plurality of multi-axial mobility elements arranged to provide similar support relative to traditional snow-riding equipment and traversed surface relationship, such as a snow-ski-edge or snowboard-edge and traversed surface relationship; minimized multidirectional friction resisting motion; a plurality of controlled-mobility elements arranged to provide similar dynamic mobility influence relative to traditional edge lining control element and traversed surface relationship; generation of friction for resisting motion for sliding, slowing, or stopping; traction directed by plurality of contact points for sliding, turning, ‘carving’; or variable geometry relating to variable performance characteristics (which may include widely varying designs and implementations).

A multidirectional support system may be formed of a plurality of multidirectional support devices. For example, a multidirectional support system may include a first multidirectional support system component and a second multidirectional support system component, each as disclosed herein. The first multidirectional support system component may be configured to attach to a first lower limb of a user, and the second multidirectional support system component is configured to attach to a second lower limb of a user, and in the manner of conventional skis, skates, and other comparable devices.

FIGS. 9 and 10 are detailed views of a multiaxial mobility element 1130 for a multidirectional support device. The multiaxial mobility element 1130 includes a support frame 1132 and Mecanum wheel 1250. Other omnidirectional wheels could be substituted for the Mecanum wheel 1250. The Mecanum wheel 1250 is configured to rotate about a main rolling axis (M) for movement across a traversed surface. The multiaxial mobility element 1130 comprises several of a secondary rolling element 1190, as shown. The secondary rolling element 1190 is mounted on a secondary-rolling-element shaft 1192, allowing the secondary rolling element 1190 to rotate about a secondary axis S. Note that each secondary-rolling-element shaft 1192 is angled with respect to the main rolling axis M, which biases the multiaxial mobility element 1130 to move at an angle relative to the main rolling axis M.

In the device of FIGS. 9 and 10, the controlled-mobility element 1220 combines with the multiaxial mobility element 1130 to provide selected behavior and interaction with the traversed surface, as disclosed herein. The controlled-mobility element 1220, featuring a tapered face 1222, is designed to engage a traversed surface when oriented to make contact therewith, thereby reducing the component of multidirectional movement parallel to the main rolling axis M (sideways).

Additionally, the Mecanum wheel 1250 is shown, characterized by its angled rollers, which enable omnidirectional movement. This wheel design allows the device to move laterally, forward, and backward.

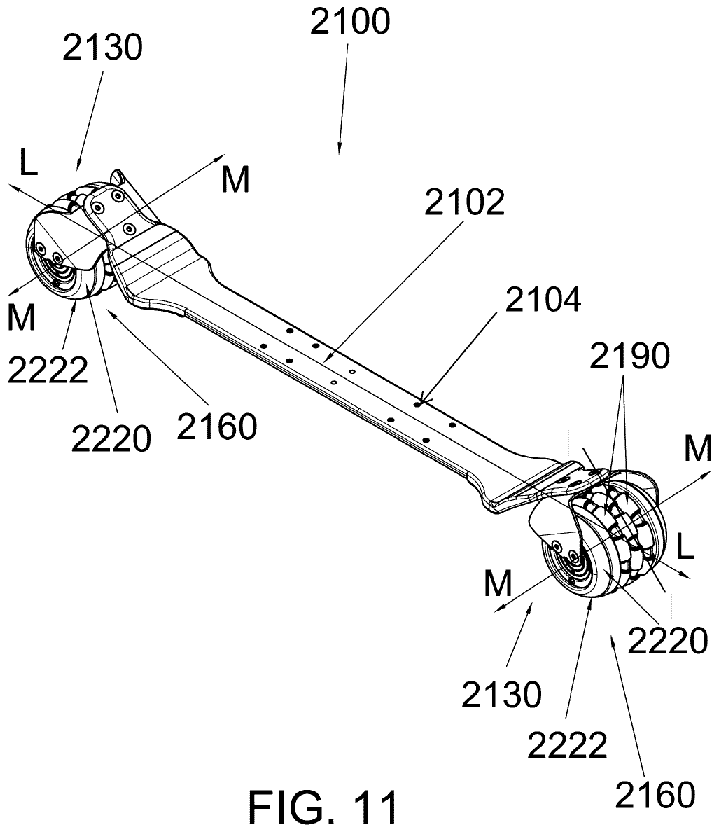

FIG. 11 shows a multidirectional support device 2100, which is configured to facilitate movement upon a traversed surface. The device comprises a base 2102, which serves as the primary structural component supporting other elements. The base 2102 includes several mounting holes 2104, which may serve as binding mounts providing a selection of locations for attaching bindings to secure a user to the base, or other elements to the base 2102. Attached to the base 2102 is a multiaxial mobility element 2130, which provides the device with enhanced multidirectional mobility. This element includes a main rolling element 2160 and a secondary rolling element 2190, both of which contribute to the device's ability to roll about their respective axes, denoted as M. The secondary rolling element 2190 (several appear in FIG. 11) has a secondary axis S, just as the secondary rolling element 190 has in FIG. 1. In any embodiment of a multidirectional support device disclosed herein, a second multiaxial mobility element may be attached to the base, as shown with the two main rolling elements 2160 in FIG. 11.

A main rolling element 2160 is positioned at each end of the base 2102. A secondary rolling element 2190 (FIG. 11 shows a plurality thereof) is also integrated into each multiaxial mobility element 2130, providing additional rolling capabilities and contributing to the overall stability and maneuverability of the device.

Additionally, the multidirectional support device 2100 includes a controlled-mobility element 2220 in the form of a control wheel. The controlled-mobility element 2220 is configured to engage with a traversed surface selectively, modulating the movement characteristics of the multidirectional support device 2100 selectively. The controlled-mobility element 2220 may have a tapered face 2222 for interacting with the traversed surface.

The configuration of the multidirectional support device 2100, with its combination of rolling and controlled-mobility elements, enables it to achieve a first stabilized equilibrium where the controlled-mobility element 2220 is not engaged with the surface. This setup allows omnidirectional movement that may then be impeded, reduced, or regulated by placing the controlled-mobility element 2220 and contact with the traversed surface and by controlling (by the user's distribution of body weight) the amount of force with which the controlled-mobility element 2220 contacts the traversed surface.

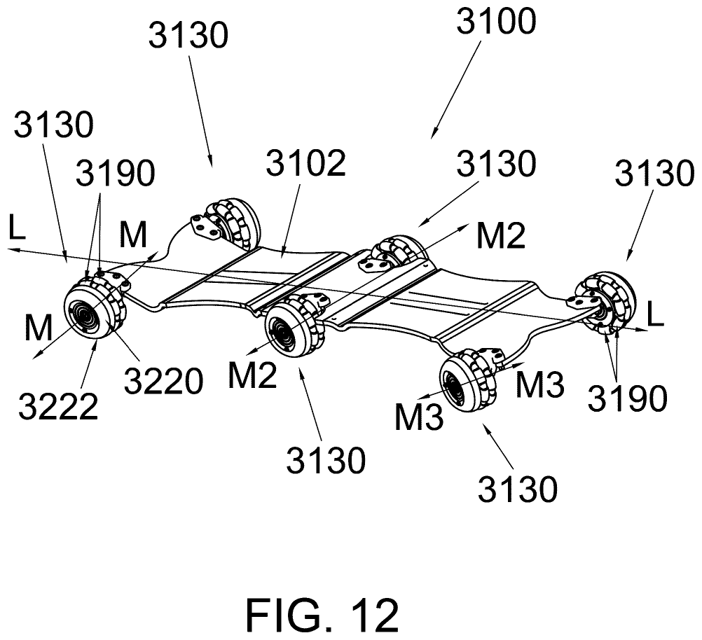

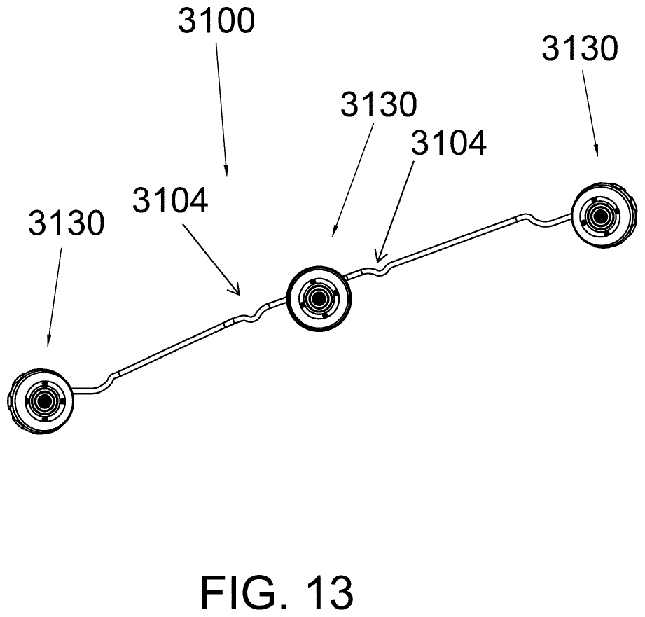

FIGS. 12 and 13 shows a multidirectional support device 3100, which is configured to facilitate movement along a linear or non-linear path defined by the orientation of a plurality of multiaxial mobility elements 3130. The device comprises a base 3102 that serves as the foundational structure. The base 3102 includes flexing regions 3104, which are regions where the base 3102 has a reduced stiffness (including reduced stiffness in bending) or a greater flexibility due to contouring, material, or other physical changes leading to the reduced stiffness. Attached to the base 3102 are several multiaxial mobility elements 3130. The multiaxial mobility elements 3130 on the near side of the longitudinal axis L in the drawings have respectively a main rolling axis M, a second main rolling axis M2, and a third main rolling axis M3.

The multidirectional support device 3100 further includes secondary rolling elements 3190, which are integrated with the multiaxial mobility elements 3130 and operate in the fashion of similarly designated elements such as element 190 described above. A controlled-mobility element 3220 in the form of a wheel is also present in each multiaxial mobility element 3130, with a tapered face 3222 aiding in directing movement and providing stability during operation. The combination of these components allows the multidirectional support device 3100 to achieve a controllable degree of maneuverability based on the degree to which the controlled-mobility elements 3220 bear against a traversed surface.

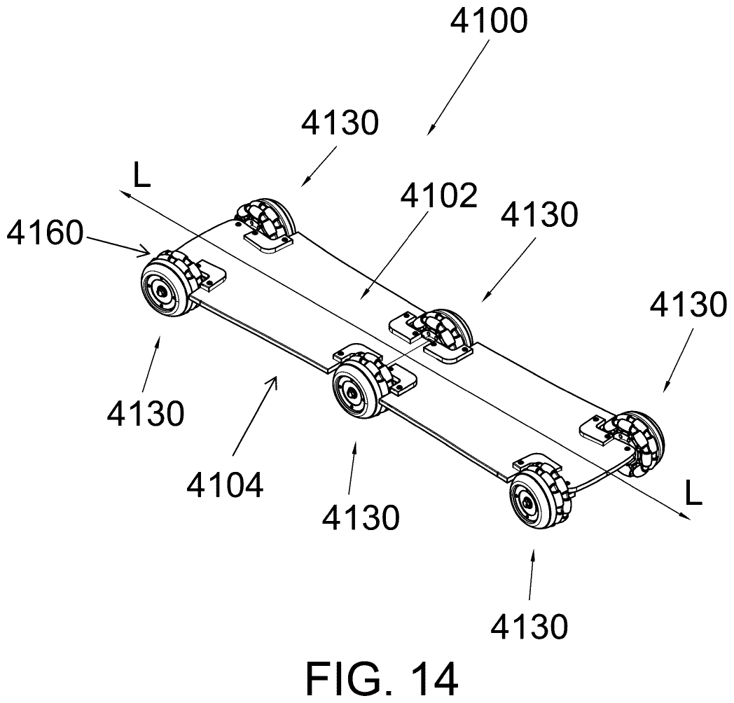

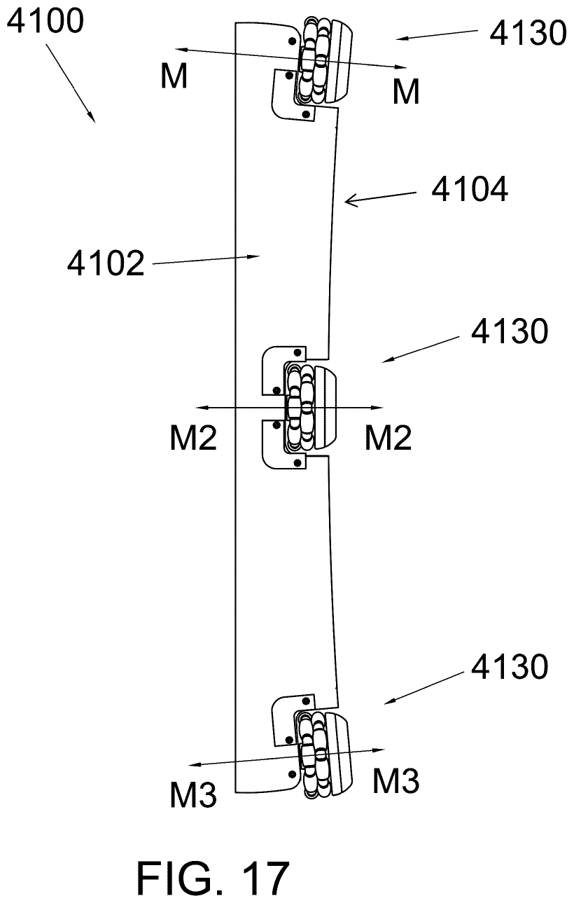

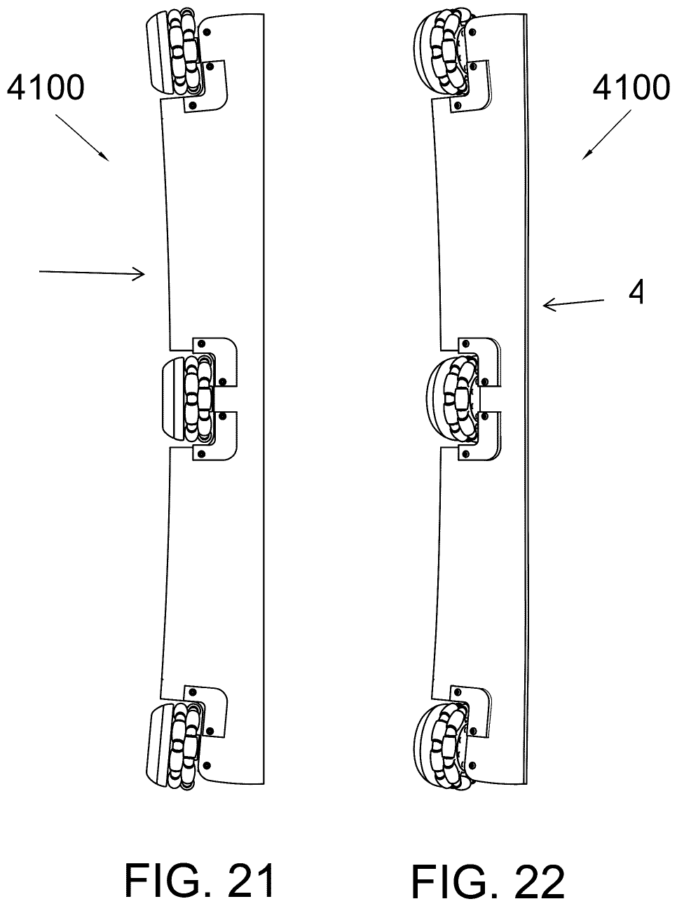

FIGS. 14-22 shows a multidirectional support device 4100, which comprises a base 4102 and multiple multiaxial mobility elements 4130. The base 4102 serves as the foundational structure to which the multiaxial mobility elements 4130 are attached. In the multidirectional support device 4100, the second multiaxial mobility element 4130 attached to the base 102 is configured to contact the traversed surface 104 at the same time as the first multiaxial mobility element 4130, and the second multiaxial mobility element 4130 has a second main rolling axis M2, and the second main rolling axis M2 is not parallel to the first main rolling axis M, so that the multidirectional support device 4100 tends to move along an a non-linear path defined by the first multiaxial mobility element 4130 and the second multiaxial mobility element 4130. The multidirectional support device 4100 may include more than two multiaxial mobility elements 4130, and each multiaxial mobility element 4130 may have a distinct main rolling axis M. The multidirectional support device 4100 as illustrated has three of the element multiaxial mobility elements 4130 on each side of a longitudinal axis L. For clarity, the multidirectional support device 4100 is shown in a partial view omitting half the device via a longitudinal section. However, the views are not designed to depict the internals of the multidirectional support device 4100 as in a typical section. Instead, the views of FIGS. 17-18 and 20-22 allow for a clearer depiction of the fact that the three axes M1, M2, and M3 are not parallel and instead are perpendicular to different points of a curved side 4104 of the base 4102.

A base of a multidirectional support device may have attached thereto a plurality of controlled-mobility elements positioned so that depending of a degree of deviation from horizontal, one of a first subset or second subset of the controlled-mobility elements contacts the traversed surface, with the first subset providing a first radius of curvature to a path of the multidirectional support device, and the second subset providing a second radius of curvature to the path of the multidirectional support device. For example, the controlled mobility element 4220 may be represented by a plurality of wheels arranged to function as the controlled mobility element as described above.)

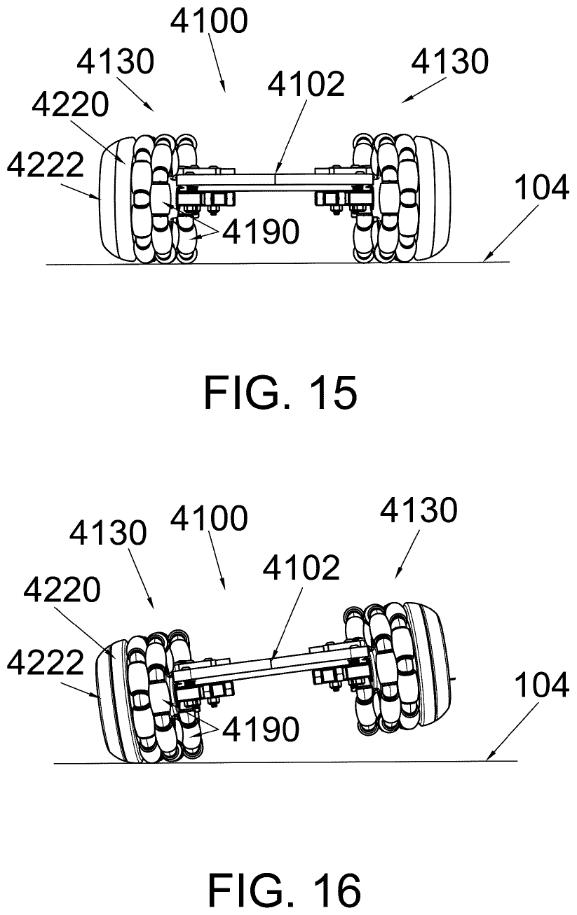

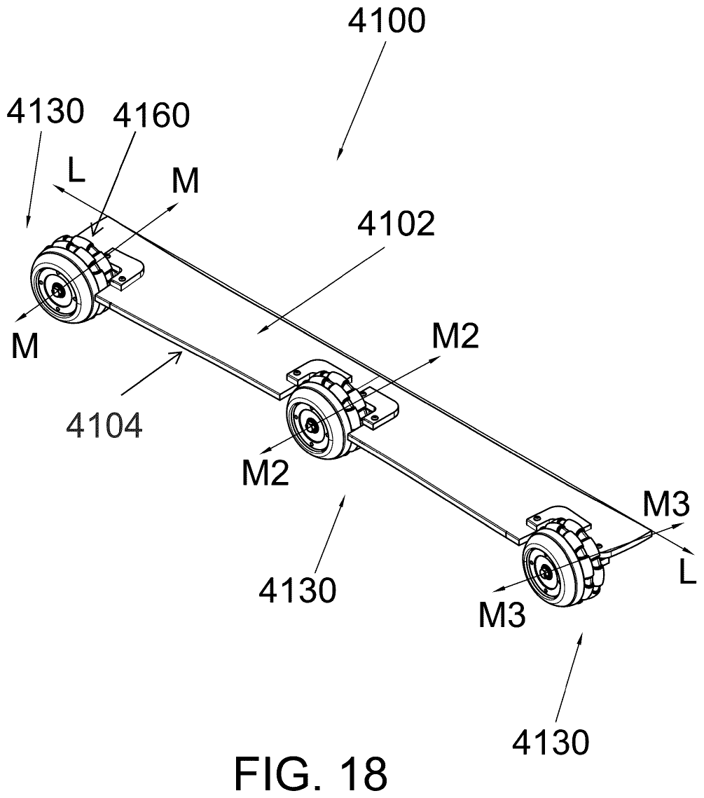

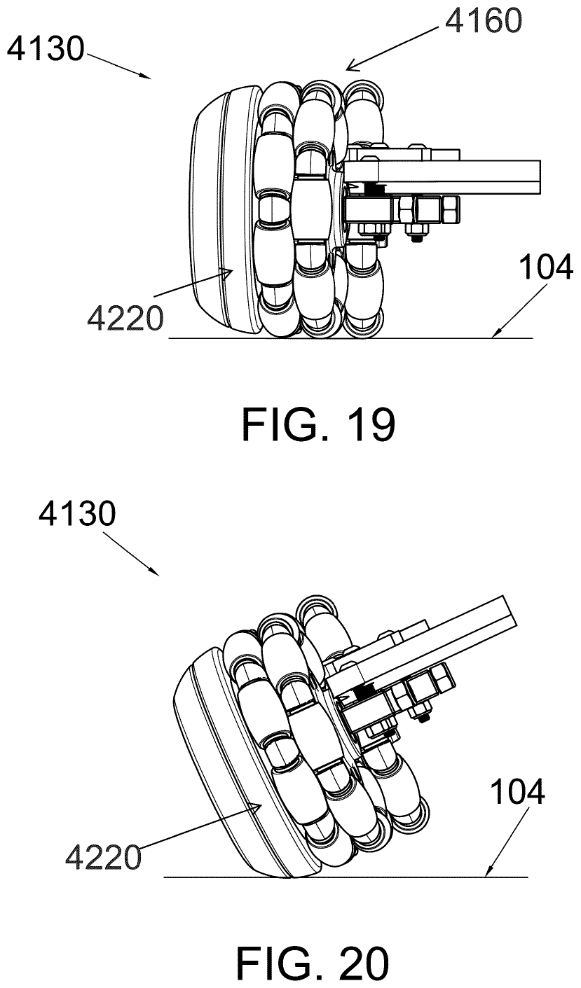

Turning to FIGS. 15-16, 19-20, and 21-22, the multidirectional support device 4100 is partially shown in a first stable equilibrium in FIGS. 15, 19, and 21 and in a second stable equilibrium in FIGS. 16, 20, and 22. (FIGS. 19-20 illustrate the multiaxial mobility element 4130, omitting the base 4102.) The multiaxial mobility element 4130 is arranged to support the base 4102 in a first stabilized equilibrium when the base 4102 is moving on the traversed surface 104 and supported on the traversed surface 104 by the multiaxial mobility element 4130, as shown in FIGS. 15 and 19. In the first stabilized equilibrium, the base 4102 has multidirectional mobility on the traversed surface 104 by virtue of the rolling of the main rolling element 4160 (FIGS. 16, 18) about the main rolling axis M and/or rolling of the secondary rolling elements 4190 about their respective secondary rolling axes. In a second stabilized equilibrium, as shown in FIGS. 16 and 20, the controlled-mobility element 4220 engages the traversed surface 104 and thereby inhibits (reduces or eliminates entirely) the multidirectional movement of the multidirectional support device 4100 parallel to the main rolling axis M. The multidirectional movement of the multidirectional support device 4100 is inhibited due to the interaction between the controlled-mobility element 4220, typically a standard wheel, which may have a tapered face 4222, and the traversed surface 104. When the multidirectional support device 4100 transitions from the first stabilized equilibrium to the second stabilized equilibrium, interaction between the controlled-mobility element 4220 and the traversed surface 104 controls and determines the behavior and path of the multidirectional support device 4100. As a result, a user or rider, by controlling a vertical orientation of the user or rider and hence an orientation of the multiaxial mobility element 4130, and/or by controlling the amount of force imposed on the controlled-mobility element 4220, can cause a transition from the first stabilized equilibrium with a relatively higher degree of multidirectional movement, to the second stabilized equilibrium, with multidirectional movement impeded and either reduced or eliminated entirely (and replaced by movement controlled by the controlled-mobility element 4220).

FIG. 17 is an upper plan view, and FIG. 18 is an upper perspective view, of the multidirectional support device 4100. As noted above, the three axes M1, M2, and M3 of the multidirectional support device 4100 are not parallel and instead are perpendicular to different points of a curved side 4104 of the base 4102. FIGS. 17 and 18 show the multidirectional support device 4100 in a first stabile equilibrium, while FIGS. 16, 20, and 22 show the multidirectional support device 4100 in a second stabile equilibrium.

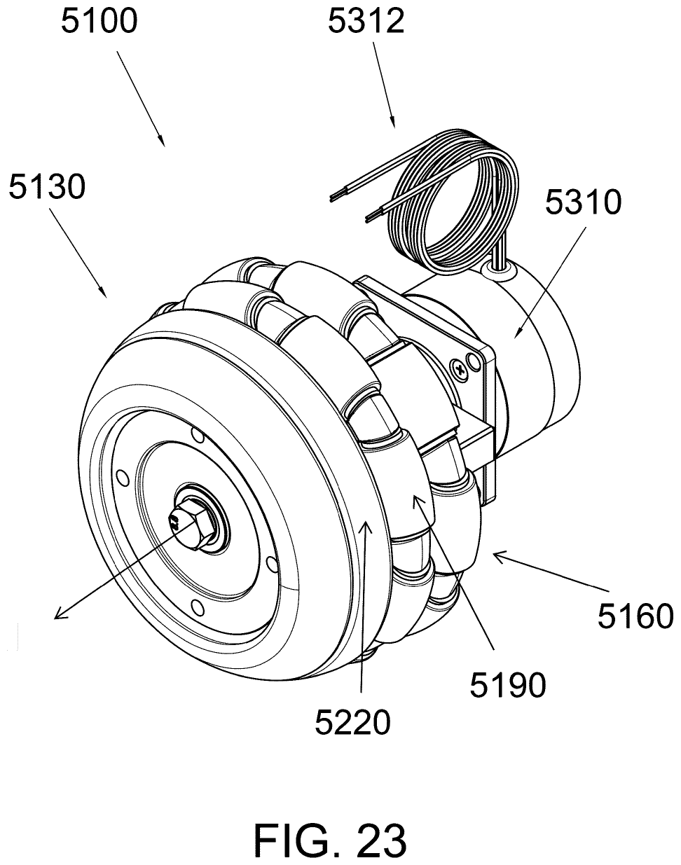

FIG. 23 shows a perspective view of a multidirectional support device 5100. The multidirectional support device 5100 as shown includes a drive unit 5310 configured to drive rotation of the main rolling element 5160 of the multiaxial mobility element 5130 about the main rolling axis M. A drive unit may include an electric motor, a fuel-powered engine, a mechanical battery, or other suitable power source. A first drive unit or a second drive unit on a multidirectional support device may include two devices driven by power takeoffs (such an input shafts) connected to a common power source of any of the types disclosed herein. The multidirectional support device 5100 may further include a second drive unit 5310 (with both being attached to a common base as disclosed herein), with the second drive unit configured to drive rotation of the secondary rolling element 5190 about the secondary rolling axis S.

The multidirectional support device 5100 incorporates the multiaxial mobility element 5130, which includes the main rolling element 5160, the secondary rolling element 5190 (several are shown), and the controlled-mobility element 5220 and facilitates movement in multiple directions as described above. The drive unit 5310 in the form of an electric drive motor is positioned adjacent to the mobility element 5130, providing the necessary power for operation. Wiring 5312 is connected to the drive motor 5310 to provide power thereto.

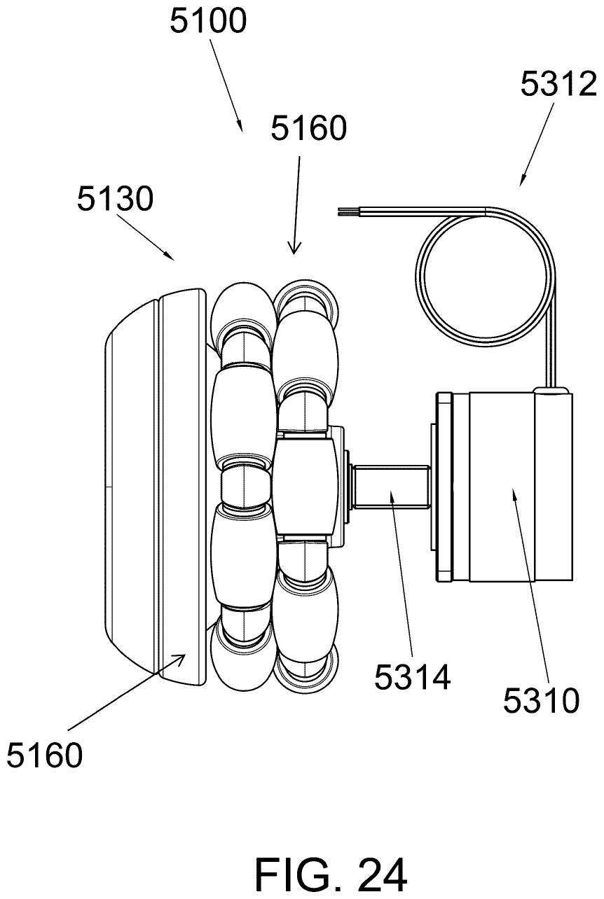

FIG. 24 is a side view of the multidirectional support device 5100. A drive shaft 5314 connects the drive unit 5310 to the multiaxial mobility element 5130 to drive the main rolling element 5160.

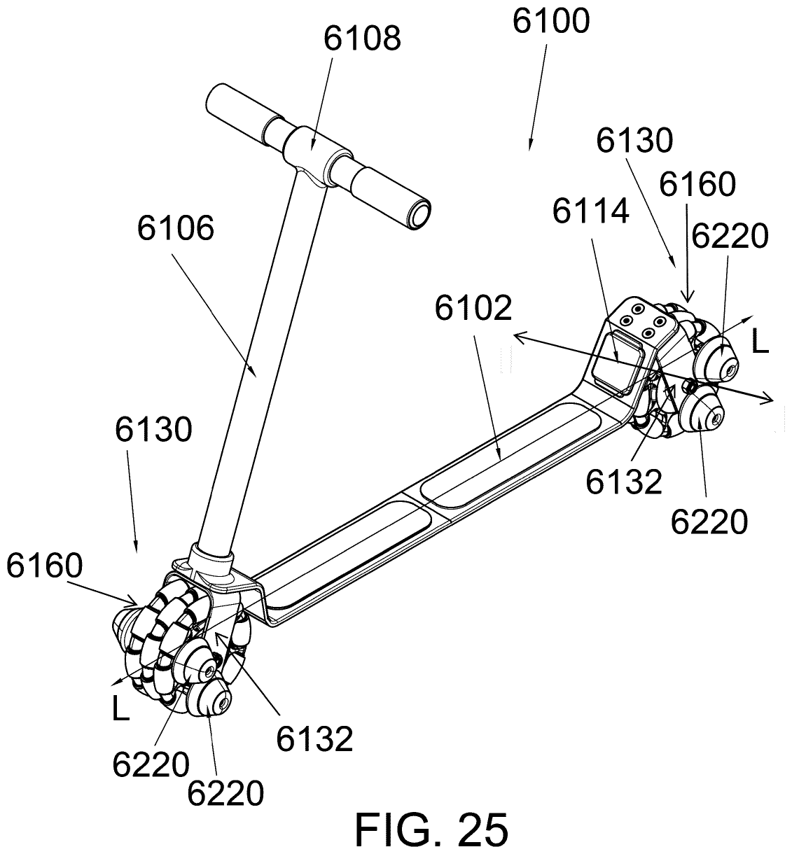

FIG. 25 shows a multidirectional scooter-type support device 6100, which has the general arrangement of a scooter, but supported by multiaxial mobility elements 6130. For purposes of this disclosure, “scooter” or “scooter sports” or “scooter-like” shall encompass all athletic or recreational activities utilizing equipment characterized by at least one foot-supporting platform integrated with a handlebar assembly and wheels or rolling elements, upon which participants stand or otherwise position themselves while propelling, balancing, steering, and maneuvering. Such activities explicitly include traditional scootering, snow scootering, and analogous activities employing similar equipment arrangements or functional characteristics.

The multidirectional support device 6100 comprises a base 6102, which serves as the primary structural component supporting the other elements. Attached to the base 6102 is a handlebar stem 6106, which extends upward and connects to a handlebar crossbar 6108, allowing for user control and maneuverability.

Additionally, the device features controlled-mobility elements 6220, which are integrated into the multiaxial mobility elements 6130. These controlled-mobility elements 6220 are configured to engage with a traversed surface to control or inhibit multiaxial mobility in the manner disclosed above.

In the multidirectional support device 6100, which takes the form of a scooter-like conveyance, a static element 6114 is displaceable along a displacement axis D with respect to the multiaxial mobility element 6130 to position the multiaxial mobility element 6130 so that the static element 6114 reduces or impedes rotation of the multiaxial mobility element 6130.

The multidirectional support device 6100 has a second multiaxial mobility element

6130 attached to the base 6102. The (first) multiaxial control element 6130 is disposed in the illustrated embodiment at a front-end portion of the base 6102 and affixed to a subbase in the form of the support frame 6132, the support frame 6132 being pivotable or rotatable with respect to the base 6102. In the illustrated embodiment, the 6102 is affixed to a handlebar stem 6106 projecting upwardly from the base 6102 to allow the subbase (support frame 6132) and the multiaxial control element 6130 attached thereto to be pivoted or rotated with respect to the base 6130. The (second) multiaxial mobility element 6130 is disposed on the base 6102 rearwardly of the multiaxial control element 6130.

In the multidirectional support device 6100, the base 6102 is configured to provide one or more of the following characteristics to a provide scooter-like conveyance: flexing regions rendering the multidirectional support device flexible; variable side-cut radius based on flexing of the base 6102; variable binding mount features; a plurality of multi-axial mobility elements arranged to provide scooter-like movement and control of the base 6102 upon a traversed surface; minimized multidirectional friction resisting motion; a plurality of controlled-mobility elements arranged to provide similar dynamic mobility; influence relative to traditional snow-scooter-edge and traversed surface relationship; generation of friction for resisting motion for sliding, slowing, or stopping; traction directed by plurality of contact points sliding, turning, ‘carving’; or variable geometry relating to variable performance characteristics (which may include widely varying designs and implementations).

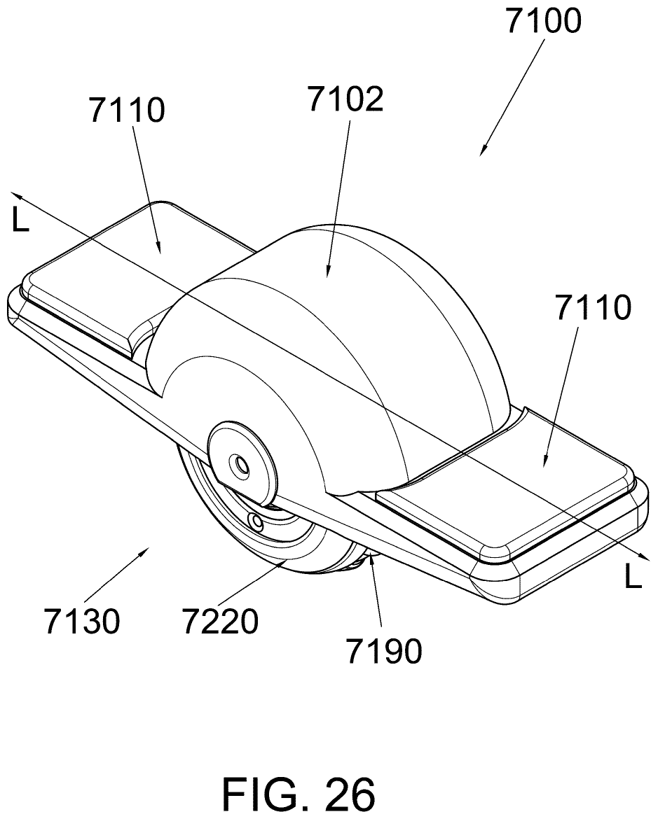

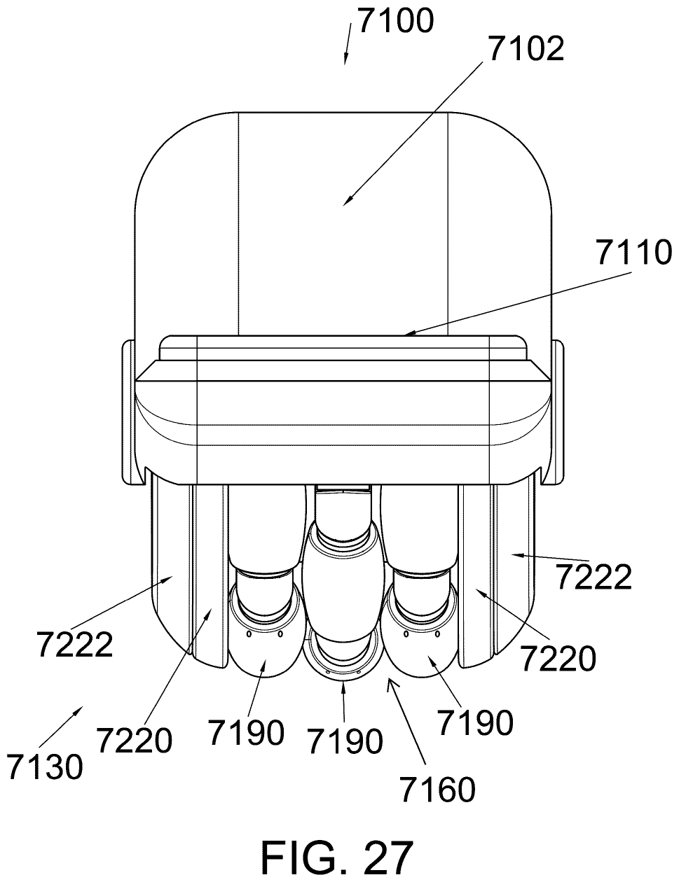

Turning to FIGS. 26-27, the illustration depicts a multidirectional support device 7100. The device comprises a base 7102, which serves as the central structural component. Attached to the base 7102 are two footrests 7110, positioned on either side of the base 7102. The multiaxial mobility element 7130 is centrally located and is sufficiently equipped to aid in balancing the base 7102. The multiaxial mobility element 7130 includes a secondary rolling element 7190, which has characteristics and functions comparable to analogous elements disclosed above. Additionally, a controlled-mobility element 7220 with a tapered face 7222 has characteristics and functions comparable to analogous elements disclosed above.

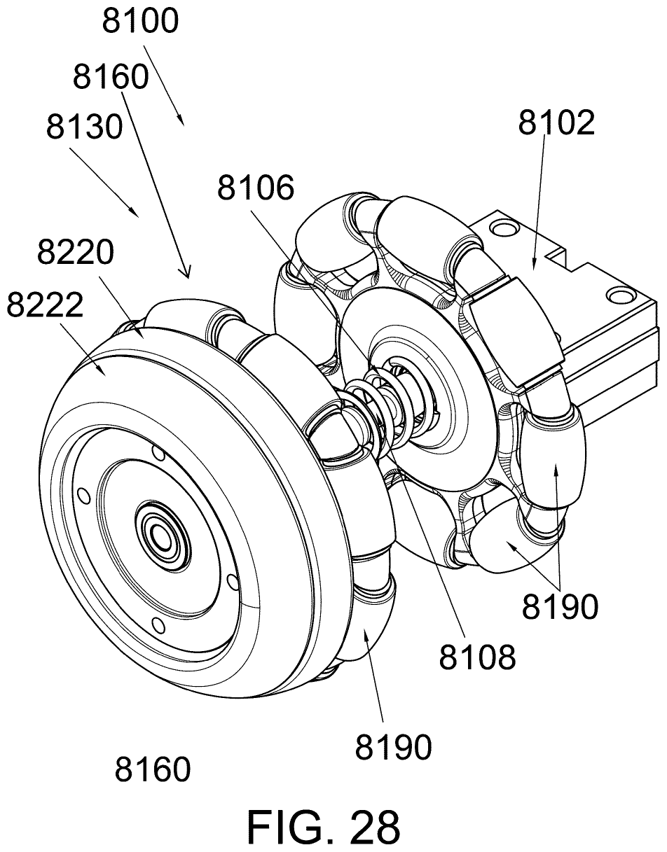

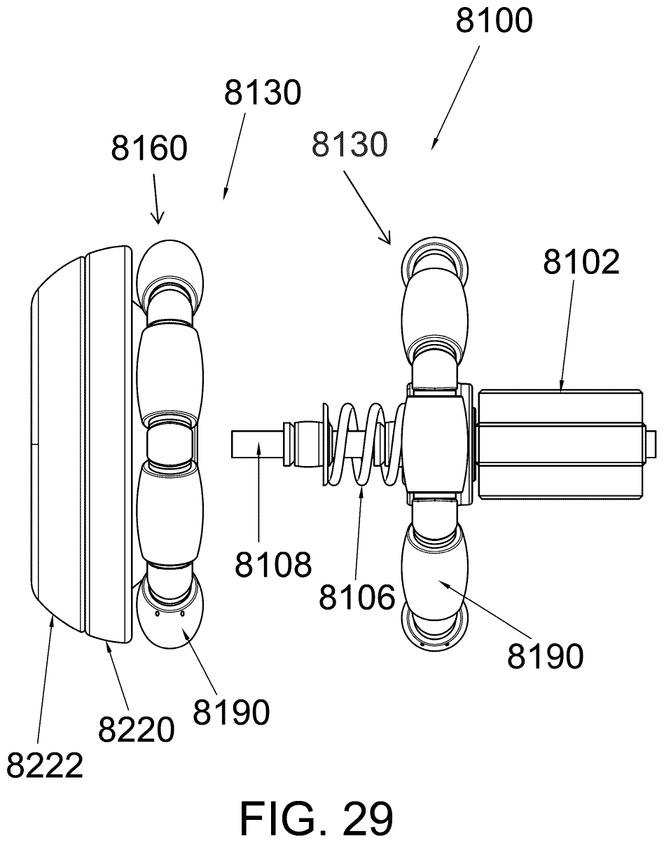

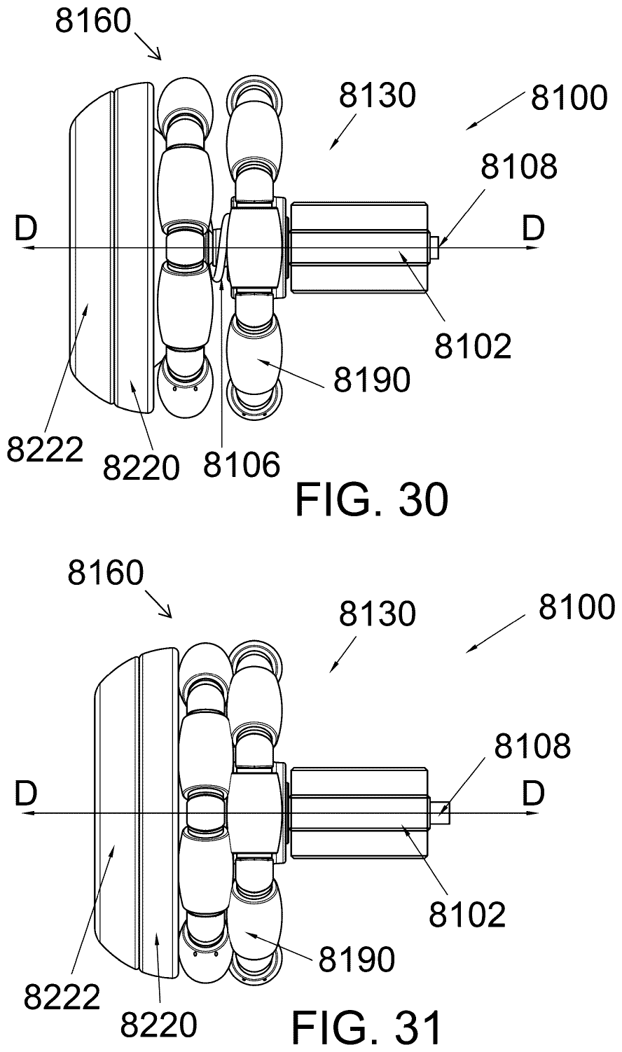

FIGS. 28-31 shows a multidirectional support device 8100, which has a base 8102 and a multiaxial mobility element 8130 analogous to those described above. The multiaxial mobility element 8130 includes main rolling element 8160, secondary mobility elements 8190, and a controlled-mobility element 8220 with a tapered face 8222. In the depicted embodiment of the multidirectional support device 8100, a first multiaxial mobility element is displaceable along a displacement axis D such that, when compressed together mutual contact points between the two elements reduce or eliminate entirely the rotation of the secondary rolling elements 8190 and therefore multidirectional movement. In the illustrated embodiment, a shaft 8108 supports the first and second multiaxial mobility elements in spaced relation, with a spring 8106 disposed to urge supports the first and second multiaxial mobility elements 8130 apart in a normal, non-braking configuration.

While specific and distinct embodiments have been shown in the drawings, various individual elements, or combinations of elements from the different embodiments may be combined with one another while in keeping with the spirit and scope of the present disclosure. Thus, an individual feature described herein only with respect to one embodiment should not be construed as being incompatible with other embodiments described herein.

It will be appreciated by those skilled in the art that various modifications and alterations could be made to the disclosure above without departing from the broad inventive concepts thereof. Some of these have been discussed above and others will be apparent to those skilled in the art. It is understood, therefore, that this invention is not limited to the particular embodiments disclosed, but it is intended to cover modifications within the spirit and scope of the present disclosure.

I claim:

1. A multidirectional support device configured to move upon a traversed surface, the multidirectional support device comprising:
(a) a base;
(b) a multiaxial mobility element attached to the base, the multiaxial mobility element including:
(i) a main rolling element having a main rolling axis (M) and a secondary rolling element having a secondary rolling axis(S), the main rolling element being configured to allow rolling about the main rolling axis (M), and the secondary rolling element being configured to allow rolling about the secondary rolling axis(S); and
(ii) the multiaxial mobility element being arranged to support the base in a first stabilized equilibrium when the base is moving on the traversed surface and supported on the traversed surface by the multiaxial mobility element, so that the base has multidirectional mobility on the traversed surface; and
(c) a controlled-mobility element configured for controlled mobility and attached to the base so that:
(i) in the first stabilized equilibrium, the controlled-mobility element does not impede a multidirectional movement of the multidirectional support device; and
(ii) in a second stabilized equilibrium, the controlled-mobility element engages the traversed surface and thereby impedes the multidirectional movement of the multidirectional support device.

2. The multidirectional support device of claim 1, wherein in the first stabilized equilibrium, the controlled-mobility element is not engaged with the traversed surface.

3. The multidirectional support device of claim 1, wherein the multiaxial mobility element includes a multiaxial wheel rotatable about a first axis, and at least one controlled-mobility element is rotatable about the first axis.

4. The multidirectional support device of claim 1, wherein the main rolling element includes one of a multidirectional wheel or a Mecanum wheel.

5. The multidirectional support device of claim 1, further comprising a second multiaxial mobility element attached to the base.

6. The multidirectional support device of claim 5, wherein the second multiaxial mobility element is attached to the base such that upon a deviation from the first stabilized equilibrium, a resulting restoring force opposing the deviation or driving a return to the first stabilized equilibrium is generated.

7. The multidirectional support device of claim 1, wherein the main rolling element has a main rolling resistance, and the secondary rolling element has a secondary rolling resistance, and the secondary rolling resistance is different from the main rolling resistance, so that the multidirectional support device tends to move with a preference for motion relative to one of the main rolling resistance or the secondary rolling resistance.

8. The multidirectional support device of claim 5, wherein the second multiaxial mobility element attached to the base is configured to contact the traversed surface at a common time with the first multiaxial mobility element, and the second multiaxial mobility element has a second main rolling axis (M), and the second main rolling axis (M) is not parallel to the first main rolling axis (M), so that the multidirectional support device tends to move along an a non-linear path defined by the first multiaxial mobility element and the second multiaxial mobility element.

9. The multidirectional support device of claim 7, wherein the multidirectional support device tends to move perpendicularly to the main rolling axis, in preference to moving parallel to the main rolling axis.

10. The multidirectional support device of claim 1, further comprising a drive unit configured to drive rotation of the main rolling element about the main rolling axis (M).

11. The multidirectional support device of claim 10, further comprising a second drive unit configured to drive rotation of the secondary rolling element about the secondary rolling axis (S).

12. The multidirectional support device of claim 1, wherein a static element is displaceable along a displacement axis (D) with respect to the multiaxial mobility element to position the multiaxial mobility element so that the static element impedes rotation of the multiaxial mobility element.

13. The multidirectional support device of claim 1, wherein the multiaxial mobility element is displaceable along an axis with respect to a second multiaxial mobility element to position the multiaxial mobility element so that the second multiaxial mobility element impedes rotation of the secondary rolling element of the multiaxial mobility element.

14. The multidirectional support device of claim 1, wherein the multidirectional support device has a longitudinal axis and includes the controlled-mobility element disposed on a first side of the longitudinal axis and a second controlled-mobility element disposed on a second side of the longitudinal axis so that if the multidirectional support device base leans to the first side or to the second side of the longitudinal axis sufficiently, the controlled-mobility device or the second controlled-mobility device engages the traversed surface, thereby reducing a multidirectional movement of the multidirectional support device.

15. The multidirectional support device of claim 4, wherein the base has dimensions and characteristics such that the multidirectional support device simulates or mimics a stability and a turning behavior of one of a rideable board-sport device.

16. The multidirectional support device of claim 4, wherein the base has dimensions and characteristics such that the multidirectional support device is appropriately predisposed for functionality as recreational equipment.

17. The multidirectional support device of claim 1, wherein:
the base has attached thereto a plurality of controlled-mobility elements positioned so that depending of a degree of deviation from horizontal, one of a first subset or second subset of the controlled-mobility elements contacts the traversed surface, with the first subset providing a first radius of curvature to a path of the multidirectional support device, and the second subset providing a second radius of curvature to the path of the multidirectional support device.

18. The multidirectional support device of claim 1, wherein the base includes binding mounts for attaching bindings to secure a user to the multidirectional support device.

19. The multidirectional support device of claim 5, further comprising:
a second multiaxial mobility element attached to the base,
wherein the multiaxial control element is disposed at a front-end portion of the base and affixed a subbase, the subbase being pivotable or rotatable with respect to the base; and
wherein the subbase is affixed to a handlebar projecting upwardly from the base to allow the subbase and the multiaxial control element attached thereto to be pivoted or rotated with respect to the base.

20. The multidirectional support device of claim 1, wherein the base further comprises:
a flexing region rendering the multidirectional support device flexible;
a side-cut radius, the side-cut radius varying based on flexing of the base due to a force imposed by a user;
binding mount features;
a plurality of multi-axial mobility elements arranged to provide similar support relative to traditional snowboard base surface and traversed surface relationship;
minimized multidirectional friction resisting motion;
a plurality of controlled-mobility elements arranged to provide similar dynamic mobility;
influence relative to traditional snowboard-edge and traversed surface relationship;
generation of friction for resisting motion for sliding, slowing, or stopping;
traction directed by plurality of contact points (sliding, turning, ‘carving’); or
variable geometry relating to variable performance characteristics (widely varying designs and implementations).

21. The multidirectional support device of claim 1, The multidirectional support device of claim 1, wherein the base is configured with characteristics providing similar support to that provided by a snow ski:
a flexing region rendering the multidirectional support device flexible;
a side-cut radius, the side-cut radius varying based on flexing of the base due to a force imposed by a user;
binding mount features;
a plurality of multi-axial mobility elements arranged to provide similar support relative to traditional snow ski and traversed surface relationship;
minimized multidirectional friction resisting motion;
a plurality of controlled-mobility elements arranged to provide similar dynamic mobility;
influence relative to traditional snow-ski-edge and traversed surface relationship;
generation of friction for resisting motion for sliding, slowing, or stopping;
traction directed by plurality of contact points (sliding, turning, ‘carving’); or
variable geometry relating to variable performance characteristics (widely varying designs and implementations).

22. A multidirectional support system comprising:
a first multidirectional support system component, the first multidirectional system component being a multidirectional support device according to claim 1; and
a second multidirectional support system component, the second multidirectional system component being a multidirectional support device according to claim 1.

23. The multidirectional support system of claim 22, wherein the first multidirectional support system component is configured to attach to a first lower limb of a user, and
wherein the second multidirectional support system component is configured to attach to a second lower limb of a user.
